(19) United States
(12) Patent Application Publication
(10) Pub. No.: US 2007/0275725 A1
(43) Pub. Date: Nov. 29, 2007

(54) Handover method and mobile terminal for wireless communication service

(75) Inventor: Katsuhiko Tsunehara, Hachioji (JP)

Correspondence Address: Stanley P. Fisher;Reed Smith Hazel & Thomas LLP, Suite 1400, 3110 Fairview Park Drive, Falls Park, VA, 22042-4503, US

(73) Assignee: Hitachi, Ltd.

(21) Appl. No.: 11/802,526

(22) Filed: May 23, 2007

(30) Foreign Application Priority Data
May 29, 2006 (JP) 2006-147574

(51) Int. Cl. H04Q 7/20

(52) U.S. Cl. 455/436

(57) ABSTRACT

A method of determining whether or not the terminal handover is executed in accordance with the communication capability available between the wireless communication terminals, wherein the communication capability is measured when each handover request is generated, when one wireless communication system currently in use is changed to another, and regularly at predetermined intervals; a terminal to be used is selected depending on the measured communication capability; and decision is made on whether or not the terminal handover is executed, depending on the result of selection.

### INCORPORATION BY REFERENCE

The present application claims priority from Japanese application JP 2006-147574 filed on May 29, 2006, the content of which is hereby incorporated by reference into this application.

### BACKGROUND OF THE INVENTION

This invention relates to a wireless communication apparatus, and more particularly to a method and an apparatus for performing the terminal handover from one terminal executing an application to another while the application is continuously executed by the terminals involved before and after the handover.

As a result of wide dissemination of mobile communication and wireless access techniques, there have come to appear various wireless communication means such as cellular telephones, wireless LANs, DSRCs (dedicated short range communication), etc. With the emerging trend of the next-generation mobile communication, the creation of a so-called hybrid system is under way wherein those various wireless communication means are interconnected with one another so that users can enjoy a uniform service or application irrespective of their choice of the wireless communication means.

FIG. 1 shows an example of what constitutes the next-generation mobile communication system. A core network 10 constitutes a basic network of the system, through which various application data and control information are transmitted. An example of the core network 10 is All-IP network.

A core network control unit 11 performs controls necessary for terminals to utilize services or applications through this system. More specifically, it realizes the access recognition function necessary for terminals to access this system or the session control function necessary for controlling the end-to-end communication sessions. In FIG. 1, the core network control unit 11 is shown in a single box for simplicity, but it is possible that the various functions of the unit 11 is individually separated from one another and installed independently on separate devices or apparatuses.

An application server 12 performs controls necessary for providing users with applications or services and also stores various data. Examples of the applications or services are the distributions of moving images, voice signals, news, etc. In FIG. 1, the application server 12 is shown as a single unit for simplicity, but a plurality of such servers may be employed.

Wireless access networks 13 and 14 provide an accessing means for connecting a terminal with the core network through wireless communication. Here, the wireless access networks 13 and 14 use wireless communication systems 15 and 16, respectively. The wireless communication systems 15 and 16 may or may not be of the same constitution. The wireless access networks 13 and 14 may be implemented by, for example, the cellular telephone network using CDMA scheme or the wireless local area network (LAN). The wireless access networks 13 and 14 include base stations which exchange radio communications with terminals and base station control units for controlling the base stations. In FIG. 1, two wireless access networks are shown, but only one wireless access network or more than two of them may be employed in the entire system.

A mobile terminal 100 is carried around by a user and connected with the wireless access network 13 via the wireless communication system 15. It is further connected with the core network 19 via the wireless access network 13 so that the terminal 100 can utilize various applications or services. It is now assumed for convenience that the mobile terminal 100 held by a user on board an automobile 20 is indicated by a reference alpha-numeral 100b while the mobile terminal 100 held by the user not on board the automobile is denoted by 100a. Here, the mobile terminal 100 is, for example, a terminal for cellular communication.

An onboard terminal 200 is installed in an automobile. It is connected with the wireless access network 14 via the wireless communication system 16 and further connected with the core network 10 via the wireless access network 14 so that it may utilize various applications or services.

The mobile terminal 100b and the onboard terminal 200 can communicate with each other through a wireless communication system 17. The wireless communication system 17 is for example a wireless LAN or a Bluetooth network. In FIG. 1, communication between the mobile terminal 100b and the onboard terminal 200 is through a wireless channel, but it may be carried out by using a wired network such as a wired LAN.

The inter-terminal handover, or simply the terminal handover, is one of the functions enabled by the next-generation mobile communication system as shown in FIG. 1. The terminal handover is such a function making it possible for a user to enjoy a single application or service continuously by switching between terminals even when the user's communication conditions or environment changes. More specifically, in case as shown in FIG. 1, the user enjoying an application provided from the application server 12 by using the mobile terminal 100, can switch from the mobile terminal 100 to the onboard terminal 200 after having moved into the automobile 20 so as to continuously enjoy the same application.

The process for enabling the terminal handover is exemplified by, for instance, the flow chart shown in FIG. 17. The mobile terminal 100 carries out communication of application data (communication 300) with the application server 12 via the wireless access network 13 and the cote network 10. When the mobile terminal 100 moves into the inside of the automobile 20 (step 301), the mobile terminal 100 exchanges information such as terminal information with the onboard terminal 200 via the communication system 17 (communication 303). Then, as a result of communication among the mobile terminal 100, the onboard terminal 200 and the core network control unit 11 is performed a registration process to enable the onboard terminal 200 to be connected with the core network 10 via the wireless access network 14 (step 304). Upon the completion of the step 304, the mobile terminal 100 sends out a terminal handover (inter-terminal handover) request 305 to the onboard terminal 200 so as to initiate the terminal handover operation. The onboard terminal 200, upon reception of the terminal handover request 305, sends out to the core network control unit 11 a control message for initiating the terminal switching (inter-terminal handover) operation (step 306). Further, communication among the mobile terminal 100, the onboard terminal 200, the core network control unit 11 and the application server 12 results in a terminal switching procecedure (inter-terminal handover procedure) (step 307) so that the user may enjoy the continued connection with the application server 12 by switching from the mobile terminal 100 to the onboard terminal 200. Consequently, the user can establish the connection between the onboard terminal 200 and the application server 12 to continue the communication of the application data (step 308). For more specific examples of the registration procedure for the onboard terminal and the terminal switching procedure step 307, reference should be made to, for example, the method disclosed in the article titled “Personal Area Network Support in All-IP Network” by Fujino et al, Society Conference BS-2-10, 2005, The Institute of Electronics Information and Communication Engineers.

### SUMMARY OF THE INVENTION

The first object of this invention will be described below. If the wireless communication system 15 used by the mobile terminal 100 is different in specification from the wireless communication system 16 used by the onboard terminal 200, the mobile and onboard terminals 100 and 200 may have different communication capabilities. The communication capability may include communication speed such as data transmission rate, communication delay, etc. Moreover, even when the wireless access networks 13 and 14 are equivalent to each other and even when the wireless communication systems 15 and 16 are equivalent to each other (i.e. when equivalent wireless access networks and equivalent wireless communication systems are used before and after the inter-terminal handover), the mobile and onboard terminals 100 and 200 may have different communication capabilities since they are separate, independent devices. Accordingly, it may happen that the communication capability of the onboard terminal 200 to be operated after handover is inferior to that of the mobile terminal operated before handover. According to the conventional handover technique as described above, however, the inter-terminal handover is carried out without evaluating in advance the communication capability of the wireless communication system used by the terminal to be involved after the handover is completed. Consequently, in the case described above, it may happen that if the terminal handover from the mobile terminal 100 to the onboard terminal 200 is executed, the application or service being enjoyed by the user is deteriorated or interrupted, and this causes inconvenience to the user. Therefore, the first object of this invention is to control the terminal handover according to the communication capabilities available in the terminals to be used before and after the inter-terminal handover.

The second object of this invention will be described below. The communication capability of the wireless communication system 16 used by the onboard terminal 200 fluctuates continuously with time due to the change in the radio environment resulting from the movement of the automobile 20. Moreover, if the onboard terminal 200 is a so-called cognitive radio terminal, which changes its available wireless communication systems from one to another according to the change in the radio environment, such a change in wireless communication system results in a large fluctuation in the communication capability of the onboard terminal 200. Accordingly, it may happen that such a large fluctuation of the communication capability causes, for example, the communication capability of the onboard terminal 200 to be deteriorated, whereby the user finds it difficult to enjoy an application or a service by means of the onboard terminal 200. According to the conventional handover technique as described above, the communication capability of the wireless communication system used by the terminal to be operated after the terminal handover is not evaluated. Consequently, in the case described above, the application or service being enjoyed by the user is deteriorated or interrupted, and inconvenience is incurred to the user. Therefore, the second object of this invention is to control the inter-terminal handover according to the fluctuation of communication capability due, for example, to the change in the radio environment.

The third object of this invention will be described below. Consideration is given to a case where the inter-terminal handover is initiated at the mobile terminals of plural users on board the automobile 20. In such a case, it may often happens that the wireless communication system 16 used by the onboard terminal 200 cannot cover the total of the communication capabilities required by the applications or services to be enjoyed by the users. Under such a condition, if the inter-terminal handover is initiated for all the user's terminals, the communication capability of the onboard terminal 200 runs short, the applications or services being enjoyed by the users are deteriorated or interrupted, and inconvenience is incurred to the users. According to the conventional handover technique as described above, a case is not anticipated where plural mobile terminals send out the requests of inter-terminal handover to a single onboard terminal and therefore the above described deterioration of convenience cannot be prevented. Therefore, the third object of this invention is to control the inter-terminal handover according to the communication capabilities required by plural users.

In attaining the above described, first to third objects of this invention, it may happen that the onboard terminal 200 and the mobile terminal 100 use different communication capabilities to execute one and the same application or service since they use, for example, different I/O devices (user interfaces). In that case, unless the handover is controlled according to the communication capability of the onboard terminal 200 required to execute applications or services, the deterioration in the quality of applications or services will be incurred when the handover takes place. Therefore, a further object of this invention is to control the inter-terminal handover according to the communication capabilities of the onboard and mobile terminals required to provide desired applications or services.

According to this invention, in order to attain the first object of the invention, when the handover is executed, the onboard terminal, which is the post-handover terminal, measures its own communication capability; decides on whether the handover is to be executed or not, depending on the measured communication capability; and the handover between the mobile terminal and the onboard terminal is executed only when the decision is that the handover is to be executed.

According to this invention, in order to attain the second object of the invention, the onboard terminal measures its own communication capability at regular intervals or whenever it changes its available communication systems; decides on whether the handover is to be executed or not, depending on the measured communication capability; and the handover between the mobile terminal and the onboard terminal is executed when the decision is that the handover is to be executed.

According to this invention, in order to attain the third object of the invention, the onboard terminal measures its own communication capability; allocates the measured communication capability to the plural mobile terminals; decides on whether the handover from the plural mobile terminals to the onboard terminal or vice versa, is to be executed or not, depending on the allocated communication capabilities; and the handover between the plural mobile terminals and the onboard terminal is executed when the decision is that the handover is to be executed.

Further, according to this invention, the decision on whether or not the terminal handover is to be executed, is made by comparing the actually obtained communication capability with the communication capability required by the terminal to be used after handover, in consideration of the communication capability required depending on the different input/output units used by the respective terminals and required for the respective terminals to execute applications.

By using the terminal handover procedure flow according to this invention, the terminal handover between the mobile terminal and the onboard terminal can be controlled in accordance with the communication capability of the onboard terminal, the communication capability required by the mobile terminal and the communication capability required for the onboard terminal to continuously execute an application or a service. Accordingly, the deterioration in the quality of an application or a service due to handover operation can be prevented even when the communication capability of the onboard terminal fluctuates due to the change in the environmental condition or the change in the wireless communication system used by the onboard terminal.

Further, by using the terminal handover procedure flow according to this invention, even where plural mobile terminals exists in an automobile, the terminal handover between the mobile terminals and the onboard terminal can be controlled in accordance with the communication capability of the onboard terminal, the communication capabilities required by the mobile terminals, the communication capability required for the onboard terminal to continuously execute an application or a service, the conditions associated with the users and the degrees of importance of applications. Accordingly, even if the number of the mobile terminals operating in the automobile changes, the deterioration in the quality of an application or a service due to handover operation can be prevented.

Other objects, features and advantages of the invention will become apparent from the following description of the embodiments of the invention taken in conjunction with the accompanying drawings.

### BRIEF DESCRIPTION OF THE DRAWINGS

FIG. 1 shows a first example of the wireless communication system to which the present invention can be applied;

FIG. 2 shows a first embodiment of the terminal handover procedure flow according to this invention;

FIG. 3 shows a second embodiment of the terminal handover procedure flow according to this invention;

FIG. 4 shows a third embodiment of the terminal handover procedure flow according to this invention;

FIG. 5 is a flow chart as an example of the terminal handover decision procedure executed by an onboard terminal;

FIG. 6 is a flow chart as a first example of the terminal selection procedure;

FIG. 7 is a flow chart as a second example of the terminal selection procedure;

FIG. 8 is a flow chart as an example of the terminal handover decision procedure executed by a mobile terminal;

FIG. 9 is a first example of the table showing the relationship between applications and their corresponding communication capabilities to be possessed by the onboard terminal;

FIG. 10 is a second example of the table showing the relationship between applications and their corresponding communication capabilities to be possessed by the onboard terminal;

FIG. 11 shows a second example of the wireless communication system to which this invention can be applied;

FIG. 12 shows a fourth embodiment of the terminal handover procedure flow according to this invention;

FIG. 13 is a flow chart as an example of the communication capability allocation and terminal handover decision procedure executed by the onboard terminal;

FIG. 14 shows a first example of the communication capability allocation procedure;

FIG. 15 shows a second example of the communication capability allocation procedure;

FIG. 16 shows in block diagram an example of the structure of the onboard terminal which executes the terminal handover procedure flow according to this invention;

FIG. 17 shows the conventional terminal handover procedure flow; and

FIG. 18 shows in block diagram an example of the structure of the mobile terminal which executes the terminal handover procedure flow according to this invention.

### DESCRIPTION OF THE EMBODIMENTS

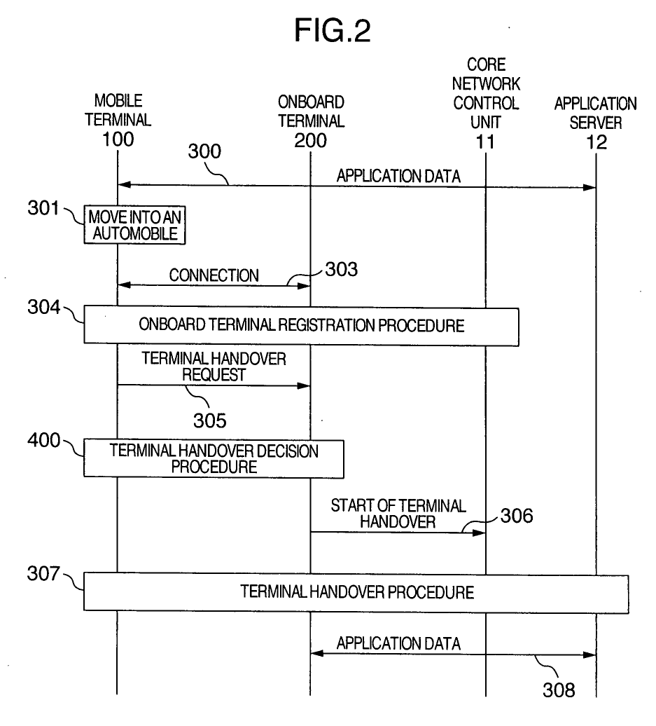

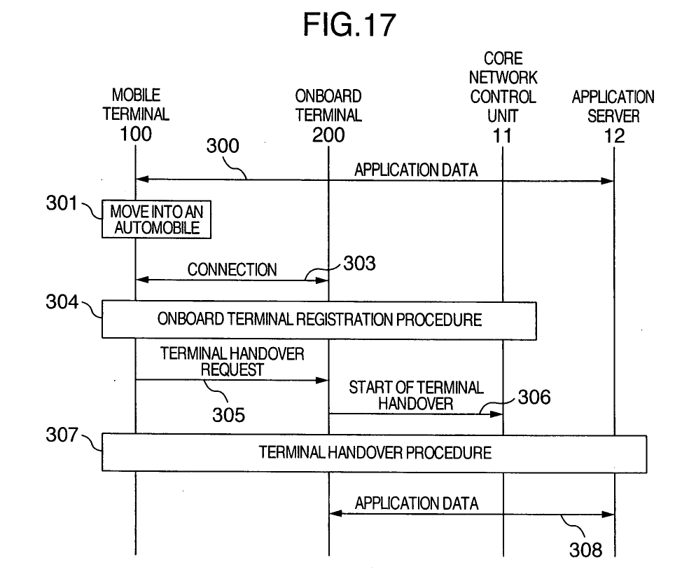

FIG. 2 shows a first embodiment of the terminal handover procedure flow according to this invention. Procedure steps or communications of the procedure flow shown in FIG. 2 are indicated at the same reference numerals as those, having the same functions, of the conventional procedure flow shown in FIG. 17. In this flow, the steps up to the terminal handover request 305 are processed in the same way as in the conventional flow. After the onboard terminal 200 has received the terminal handover request 305 from the mobile terminal 100, the onboard terminal 200 executes the terminal handover decision procedure 400 for deciding on whether the terminal handover is to be executed or not, by using, for example, the application information received from the mobile terminal 100. The detail of the terminal handover decision procedure 400 will be described later. If the decision in the terminal handover decision procedure 400 is that the terminal handover is to be executed (for simplicity of diagram, this conditional branching is not shown in FIG. 2), the onboard terminal 200 sends out the start 306 of terminal handover to the core network control unit 11 in the same way as in the conventional procedure flow shown in FIG. 17. Accordingly, the terminal handover procedure 307 is executed so that the handover from the mobile terminal 100 to the onboard terminal 200 is performed. When the terminal handover is not to be executed, the content registered in the onboard terminal registration procedure 304 is cancelled and the communication 300 of the application data is continued.

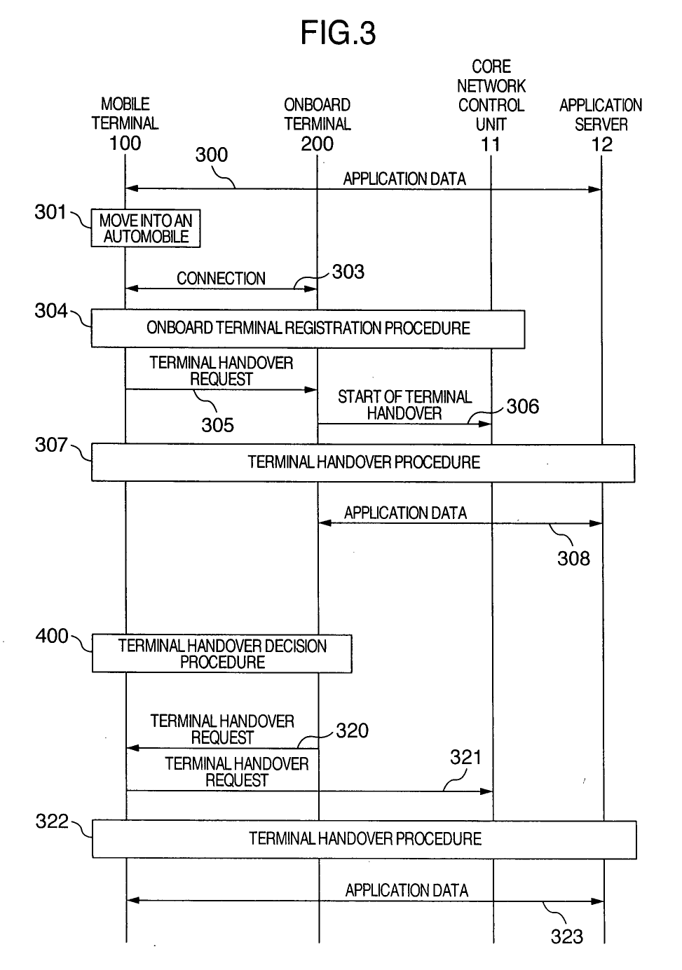

FIG. 3 shows a second embodiment of the terminal handover procedure flow according to this invention. Procedure steps or communications of the procedure flow shown in FIG. 3 are indicated at the same reference numerals as those, having the same functions, of the conventional procedure flow shown in FIG. 17 and of the first embodiment shown in FIG. 2. In FIG. 3, the procedure flow between the application data communication 300 and the application data communication 308 is processed in the same way as in the conventional flow shown in FIG. 17. Upon completion of the terminal handover from the mobile terminal 100 to the onboard terminal 200 according to the conventional flow, the onboard terminal 200 executes regularly at predetermined intervals the terminal handover decision procedure 400 for deciding on whether or not the terminal handover to the mobile terminal 100 is to be executed (for simplicity of diagram, the regularly executed state transitions are not shown in FIG. 3). The detail of the terminal handover decision procedure 400 will be described later. If the decision in the terminal handover decision procedure 400 is that the terminal handover is to be executed (for simplicity of diagram, this conditional branching is not shown in FIG. 3), the onboard terminal 200 and the mobile terminal 100 start the procedure necessary to execute the handover from the onboard terminal 200 to the mobile terminal 100. More specifically, the onboard terminal 200 sends out the terminal handover request 320 to the mobile terminal 100 and then the mobile terminal 100, after receiving the request, sends out the terminal handover request 321 to the core network control unit 11. Thereafter, the terminal handover procedure 322 is executed among the mobile terminal 100, the onboard terminal 200, the core network control unit 11 and the application server 12 so that the terminal handover from the onboard terminal 200 to the mobile terminal 100 is performed.

It is noted that the procedure flow between the application data 300 and 308 shown in FIG. 3 can be replaced by another procedure flow such as, for example, the procedure flow shown as the first embodiment in FIG. 2.

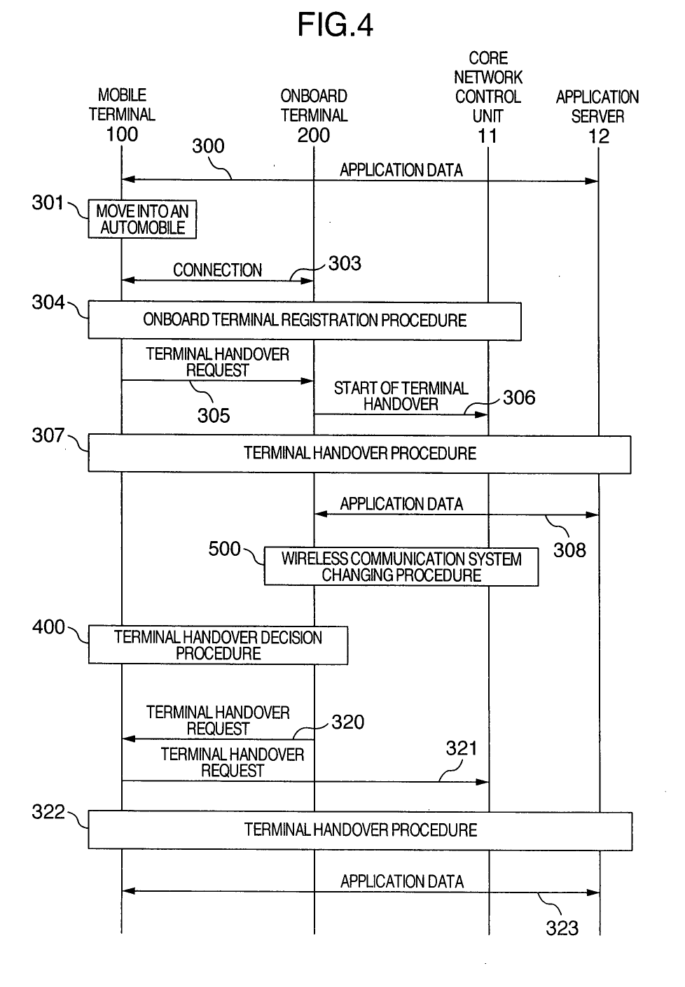

FIG. 4 shows a third embodiment of the terminal handover procedure flow according to this invention. Procedure steps or communications of the procedure flow shown in FIG. 4 are indicated at the same reference numerals as those, having the same functions, of the conventional procedure flow shown in FIG. 17, of the first embodiment shown in FIG. 2, and of the second embodiment shown in FIG. 3. In FIG. 4, the procedure flow between the application data communication 300 and the application data communication 308 is processed in the same way as in the conventional flow shown in FIG. 17. In this embodiment, a case is assumed where the onboard terminal 200 changes its available communication systems, that is, a so-called system handover is executed, upon completion of the terminal handover from the mobile terminal 100 to the onboard terminal 200. As the onboard terminal 200 executes the system handover according to the communication system changing procedure 500, the onboard terminal 200 executes the terminal handover decision procedure 400 for deciding on whether the terminal handover is to be executed or not. The detail of the terminal handover decision procedure 400 will be described later. If the decision in the terminal handover decision procedure 400 is that the terminal handover is to be executed (for simplicity of diagram, this conditional branching is not shown in FIG. 4), the onboard terminal 200 and the mobile terminal 100 execute the same procedure as shown as the second embodiment in FIG. 3 so that the terminal handover from the onboard terminal 200 to the mobile terminal 100 is performed.

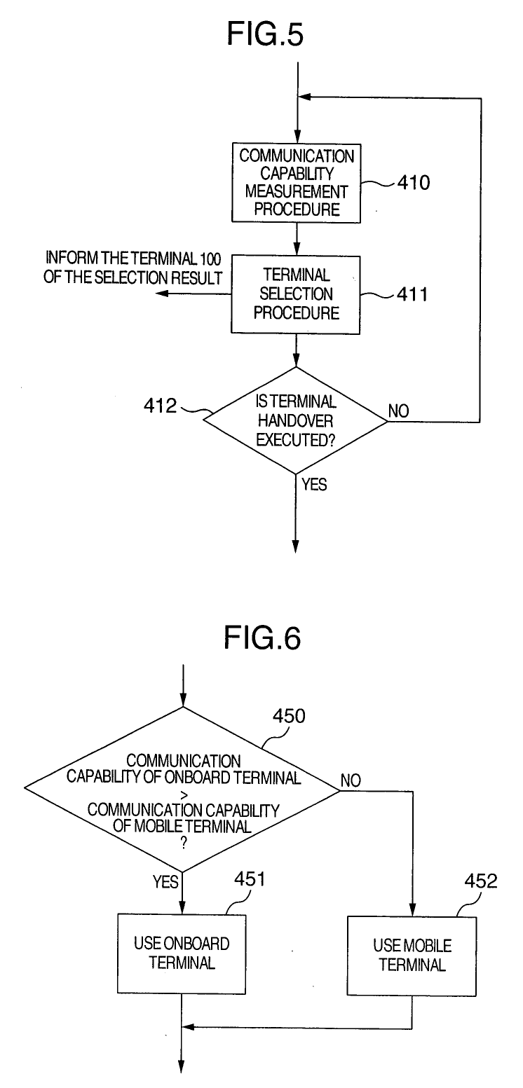

In the following is described the detail of the terminal handover decision procedure 400 shown in FIGS. 2 through 4. FIG. 5 is a flow chart as an example of the terminal handover decision procedure 400 executed by the onboard terminal 200. First, the onboard terminal 200 executes the communication capability measurement procedure 410 for measuring the communication capability of the wireless communication system used by the onboard terminal 200. Then, on the basis of its own communication capability obtained through the communication capability measurement procedure 410, the onboard terminal 200 executes the terminal selection procedure 411 for deciding on whether the onboard terminal 200 is used for the continuous execution of an application or the mobile terminal 100 is used for the same purpose. The detail of the terminal selection procedure 411 will be described later. The onboard terminal 200 informs the mobile terminal 100 of the decision obtained through the terminal selection procedure 411. Further, on the basis of the decision obtained through the terminal selection procedure 411, the onboard terminal 200 decides on whether the terminal handover is to be executed or not (step 412). In the step 412, while the mobile terminal 100 is executing the application, the flow follows the “Yes” branch when the terminal selection procedure 411 selects the onboard terminal 200, but it follows the “No” branch when the terminal selection procedure 411 selects the mobile terminal 100. When the step 412 selects the “Yes” branch, the procedures after the terminal handover decision procedure 400 shown in FIG. 2 through 4 are executed so that the terminal handover is performed. On the other hand, when the step 412 selects the “No” branch, the onboard terminal 200 executes the communication capability measurement procedure 410 again, or shifts to the state of waiting for the re-execution of the communication capability measurement 410.

FIG. 6 is a flow chart as a first example of the terminal selection procedure 411 shown in FIG. 5. In the step 450, the onboard terminal 200 decides on whether or not its own communication capability is higher than the communication capability of the mobile terminal 100. It is noted here that the communication capability of the onboard terminal 200 can be obtained through the communication capability measurement procedure 410 shown in FIG. 5. The communication capability of the mobile terminal 100 can be obtained by causing the mobile terminal 100 to inform the onboard terminal 200 of the communication capability of the mobile terminal 100 in the terminal handover request 350 shown in the procedure flows in FIG. 2 through 4. If the above mentioned condition is satisfied in the step 450, the onboard terminal 200 outputs “Use Onboard Terminal” as the result of the terminal selection procedure 411 (step 451). On the other hand, if the above mentioned condition is not satisfied in the step 450, the onboard terminal 200 outputs “Use Mobile Terminal” as the result of the terminal selection procedure 411 (step 452).

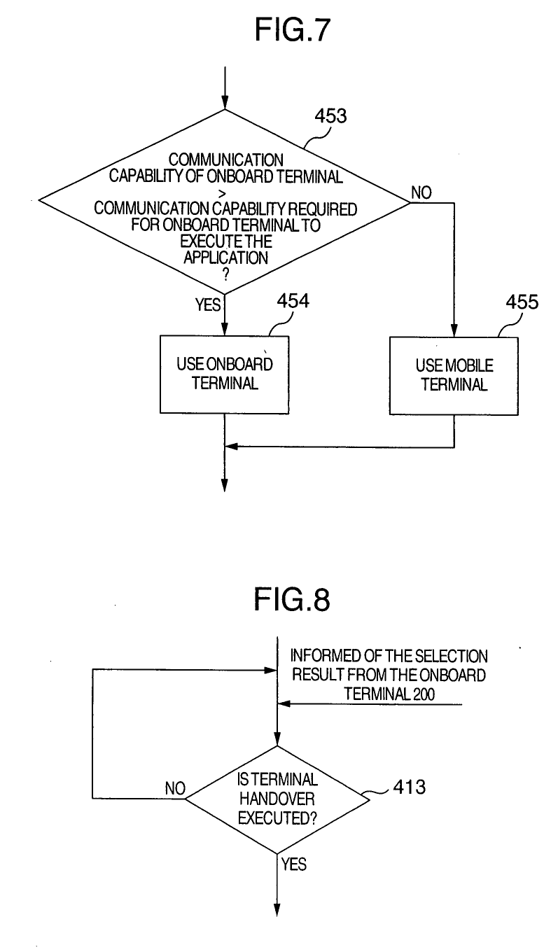

FIG. 7 is a flow chart as a second example of the terminal selection process 411 shown in FIG. 5. In step 453, the onboard terminal 200 decides on whether or not its current communication capability is higher than the communication capability required for it to execute the application. It is noted here that the current communication capability of the onboard terminal 200 can be obtained through the communication capability measurement procedure 410 shown in FIG. 5. The way of obtaining the communication capability required for the onboard terminal 200 to execute the application will be described later. If the above mentioned condition is satisfied in the step 453, the onboard terminal 200 outputs “Use Onboard Terminal” as the result of the terminal selection procedure 411 (step 454). On the other hand, if the above mentioned condition is not satisfied in the step 453, the onboard terminal 200 outputs “Use Mobile Terminal” as the result of the terminal selection procedure 411 (step 455).

The way of obtaining the communication capability required for the onboard terminal 200 to execute an application will be described in two examples as follows.

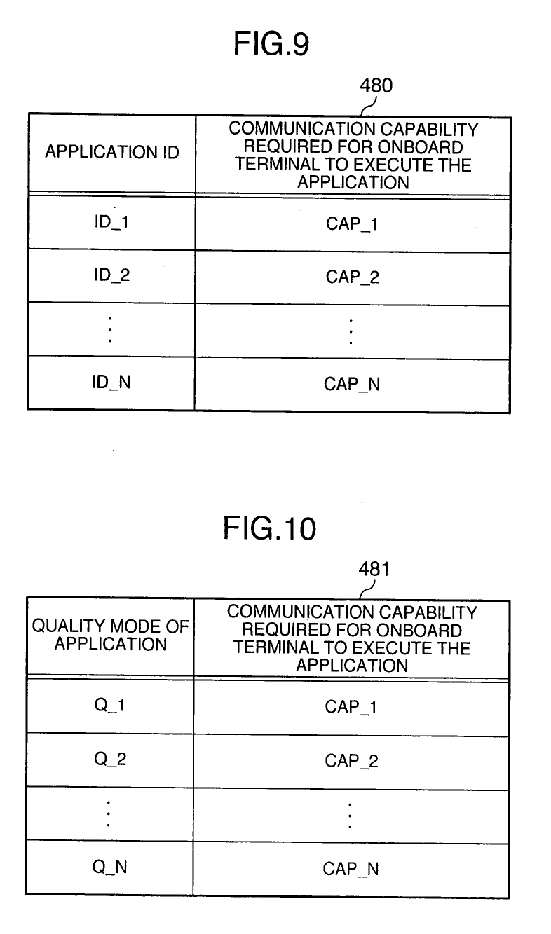

The first example is as follows. In the terminal handover request 350 shown in the procedure flows in FIGS. 2 through 4, the onboard terminal 200 is caused to be informed of the ID (hereafter referred to as application ID) for specifying the application which the onboard terminal 200 takes over from the mobile terminal 100. The onboard terminal 200 holds in advance the table 480 (shown in FIG. 9) in which the application IDs are associated with the corresponding communication capabilities required for the onboard terminal 200 to execute the applications specified by the application IDs. In this way, the onboard terminal 200 can obtain, through the use of the table 480, the communication capabilities (e.g. CAP_1) required for the onboard terminal 200 to execute the applications specified by the application IDs (e.g. ID_1) informed of by the mobile terminal 100.

The second example of the way of obtaining the communication capability required for the onboard terminal 200 to execute an application is as follows. As in the first example described above, the onboard terminal 200 specifies, through the use of the application ID informed of by the mobile terminal 100, the application which the onboard terminal 200 takes over from the mobile terminal 100. Then, the onboard terminal 200 obtains the table 481 (shown in FIG. 10) in which the quality modes of the specified applications are associated with the corresponding communication capabilities required to obtain the listed qualities. It is noted here that the onboard terminal 200 may beforehand hold the table 481 or that the onboard terminal 200 may obtain the table 481 by accessing the application server 12 after specifying the application of interest. The quality modes of applications include, for example, the distinction between high resolution mode and low resolution mode, the distinction between audio communication mode and audio-video communication mode, etc. The onboard terminal 200 specifies the quality mode with which the onboard terminal 200 executes the application of interest, on the basis of, for example, display size. By the use of the thus obtained quality mode (e.g. Q_2) and the table 481, the onboard terminal 200 can obtain the communication capability (e.g. CAP_2) required to execute the application which the onboard terminal 200 takes over from the mobile terminal 100.

FIG. 8 is a flow chart as an example of the terminal handover decision procedure 400 executed by the mobile terminal 100, shown in FIGS. 2 through 4. The mobile terminal 100 decides on whether or not the terminal handover is to be executed (step 413), on the basis of the result of the decision informed of by the onboard terminal 200 in the terminal selection procedure 411 shown in FIG. 5. The operation in the step 413 is the same as the operation in the step 412 in FIG. 5 and therefore the description thereof is omitted. When the “Yes” branch is followed in the step 413, the procedures after the terminal handover decision procedure 400 shown in FIGS. 2 through 4 are executed so that the terminal handover is performed. On the other hand, when the “No” branch is followed in the step 413, the mobile terminal 100 shifts to the state where it waits for the result of the decision provided from the onboard terminal 200 (as in the embodiments shown in FIGS. 3 and 4), or to the state where it is ready to send out the terminal handover request 305 again (as in the embodiment shown in FIG. 2). In FIG. 8, for simplicity of flow layout, only the former state is shown, the latter state being omitted.

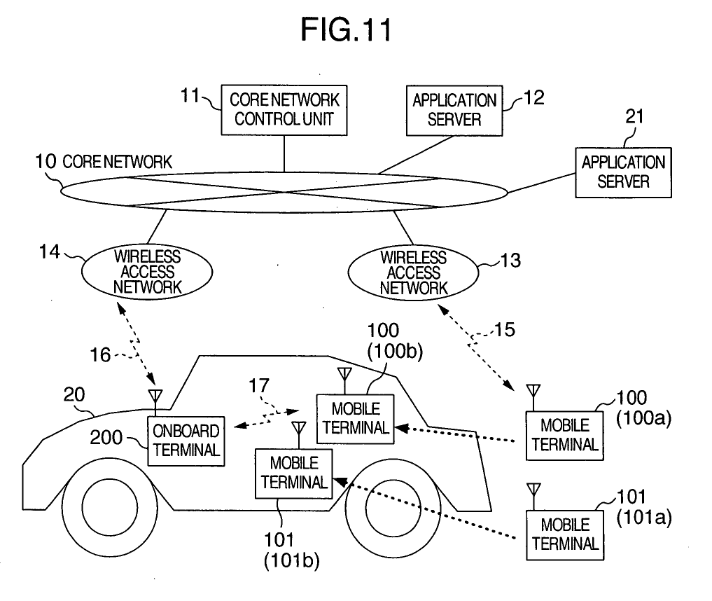

The fourth embodiment of the terminal handover procedure flow according to this invention will now be described with reference to FIGS. 11 through 15. The same reference numerals used in the figures referenced already are applied to the equivalent elements shown in FIGS. 11 through 15. In this fourth embodiment of the invention, the terminal handover procedure flow disclosed in this invention is described in the case where one onboard terminal and plural mobile terminals are involved.

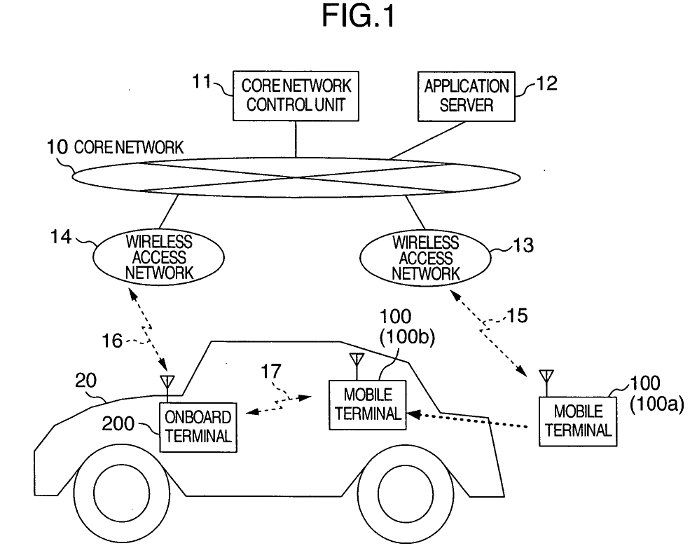

FIG. 11 shows the overall structure of the wireless communication system to which the fourth embodiment of the terminal handover procedure flow according to this invention is intended to be applied. The difference of FIG. 11 from FIG. 1 is in that there are plural mobile terminals in the system shown in FIG. 11. In FIG. 11, a mobile terminal 101 as the second mobile terminal is included in the system in addition to the mobile terminal 100 operating as the first mobile terminal. It is noted here that the mobile terminal 101 is indicated at reference alpha-numeral 101a when it is operated within the automobile 20 and at 101b when it is operated outside the automobile 20. Now, it is assumed that the mobile terminals 100 and 101 are connected with the application servers 12 and 21, respectively, and are both executing applications. In the example shown in FIG. 11, the mobile terminals 100 and 101 are connected with the core network 10 through the same wireless communication system 15 and the same wireless access network 13, but these connections may be established through separate communication systems and wireless access networks. Further, in the example shown in FIG. 11, the mobile terminals 100 and 101 communicates with the onboard terminal 200 through the same wireless communication system 17, but they may communicate with the onboard terminal 200 by using separate wireless communication systems.

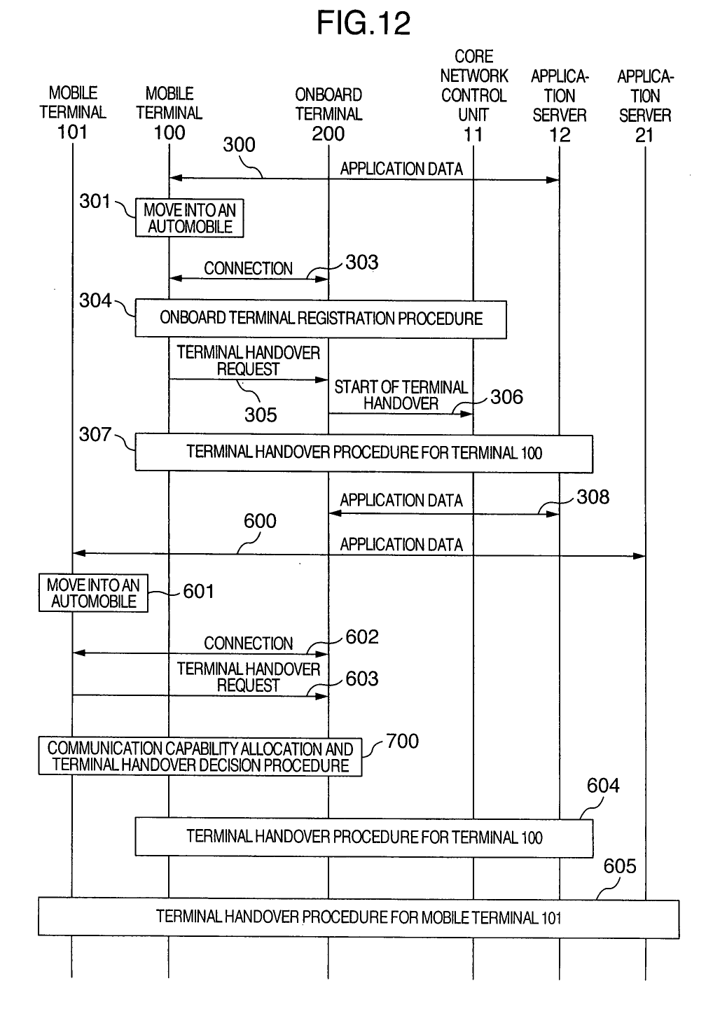

The fourth embodiment of the terminal handover procedure flow according to this invention is described with reference to FIG. 12. The procedure flow between the application data communication 300 and the application data communication 308 in FIG. 12 is the same as the corresponding portion of the conventional procedure flow in FIG. 17. It is also noted here that the procedure flow shown as the first embodiment in FIG. 2 may be used as the procedure flow between the application data communication 300 and the application data communication 308 in FIG. 3.

In the following, the fourth embodiment of the terminal handover procedure flow will be described as applied to the case where after the terminal handover from the mobile terminal 100 to the onboard terminal 200 has been completed according to the above described procedure flow, the mobile terminal 101 moves into the automobile (step 601) while being under the application data communication with the application server 21.

The mobile terminal 101, after having moved into the automobile, is connected with the onboard terminal 200 through communication 602 and sends out terminal handover request 603 to the onboard terminal 200. The communication 602 and the terminal handover request 603 are the same as the communication 303 and the terminal handover request 305 associated with the mobile terminal 100. Upon reception of the terminal handover request 603 from the mobile terminal 101, the onboard terminal 200 allocates the corresponding communication capabilities to the mobile terminals and executes the communication capability allocation and terminal handover decision procedure 700 for deciding on whether or not the terminal handover is to be executed, with respect to the mobile terminals. The details of the communication capability allocation and terminal handover decision procedure 700 will be described later.

When the result of the communication capability allocation and terminal handover decision procedure 700 is the decision that the handover is to be executed with respect to the mobile terminal 100 (for simplicity of flow diagram, this branching condition is not shown in FIG. 12), the onboard terminal 200 and the mobile terminal 100 are subjected to the terminal handover from the onboard terminal 200 to the mobile terminal 100 according to the terminal handover procedure 604 for the mobile terminal 100. As the terminal handover procedure 604 for the mobile terminal 100 may be used the procedure between the terminal handover request 320 and the application data communication 323, shown in the second embodiment in FIG. 3. On the other hand, when the decision of the communication capability allocation and terminal handover decision procedure 700 is that the handover is to be executed with respect to the mobile terminal 101 (for simplicity of flow diagram, this branching condition is not shown in FIG. 12), the onboard terminal 200 and the mobile terminal 101 are subjected to the terminal handover from the mobile terminal 101 to the onboard terminal 200 according to the terminal handover procedure 605 for the mobile terminal 101. As the terminal handover procedure 605 for the mobile terminal 101 may be used the procedure between the terminal handover request 305 and the application data communication 308, shown in FIG. 2 or 17.

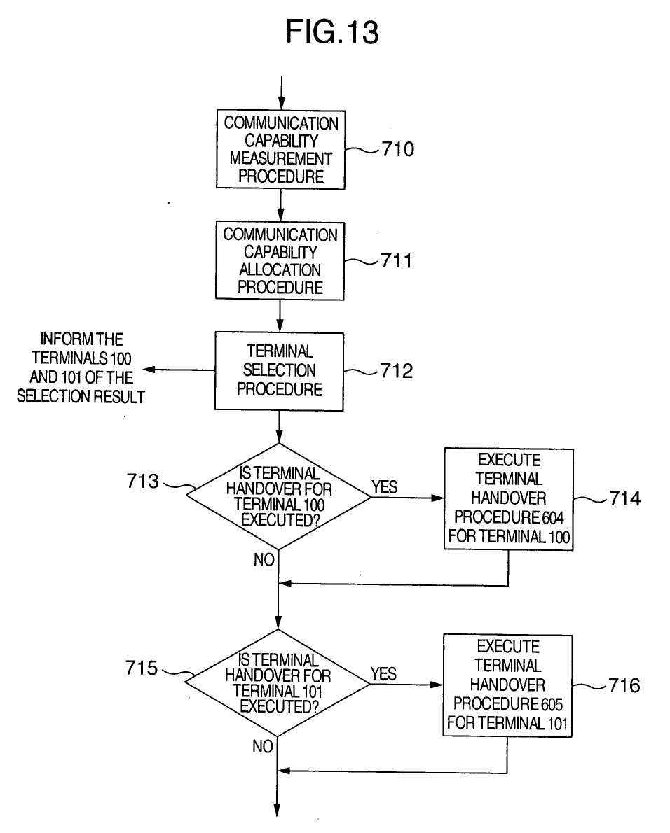

FIG. 13 is a flow chart as an example of the communication capability allocation and terminal handover decision procedure 700 executed by the onboard terminal 200. First, the onboard terminal 200 executes the communication capability measurement procedure 710 for measuring the communication capability of the wireless communication system which the onboard terminal 200 uses. Then, the onboard terminal 200 executes the communication capability allocation procedure 711 for allocating the communication capability measured through the communication capability measurement procedure 710 to the respective mobile terminals.

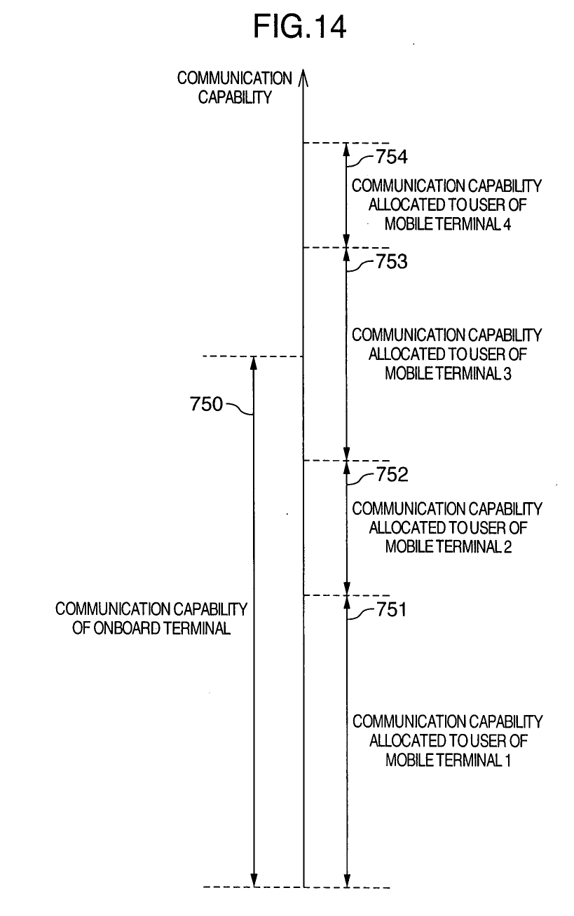

FIG. 14 shows a first example of the communication capability allocation procedure 711. In FIG. 14 is shown the case where the communication capability of the onboard terminal 200 is allocated to four user's mobile terminals. First, the onboard terminal 200 gives priority to the respective users of the mobile terminals, to which the users have to be subjected in the terminal handover to the onboard terminal 200. In the example shown in FIG. 14, it is assumed that the user of the mobile terminal 1 is given the highest priority while the user of the mobile terminal 4 is given the lowest priority.

The rule of giving priority to the users may be that higher priority is given to the user of the mobile terminal to which greater communication capability is allocated.

Alternatively, the rule of giving priority to the users may be determined depending on the users' situations. For example, the highest priority is given to the user who is driving an automobile while the second highest priority is given to the user who is seated in the assistant seat in the automobile.

Or the rule may be considered depending on the applications or the services which the users desire. For example, higher priority is given to applications or services such as telephone calls or emergency messages that are higher in the degree of importance or urgency while lower priority is given to applications or services dedicated to amusement, such as moving images or animated pictures.

Further, the rule may be created depending on the effectiveness of terminal handover. For example, higher priority is given to applications or services such as games or animated pictures whose values or degrees of satisfaction are greater when they are executed on a onboard terminal having a larger display than when they are executed on a mobile telephone set having a relatively small display, while lower priority is given to such applications or services as e-mails whose values or degrees of convenience do not change so much when displayed on the larger display of the onboard terminal or on the smaller display of the mobile telephone set.

Moreover, a simple rule may be established wherein top priority is given to the user whose mobile terminal is initially involved in the terminal handover to the onboard terminal and the onboard terminal does not accept any additional terminal handover request unless it has enough communication capability to accommodate further terminal handovers.

Each of the rules of giving priority described above may be adopted independently or some of the rules may be employed in combination.

As shown in FIG. 14, according to the priority established as described above, the onboard terminal 200 allocates its communication capability 750 to the respective mobile terminals 1 through 4. As the communication capability to be allocated can be used the communication capabilities of the respective terminals as described with reference to FIG. 6, or the communication capability required for the onboard terminal to execute the applications or services executed by the respective mobile terminals as described with reference to FIG. 7.

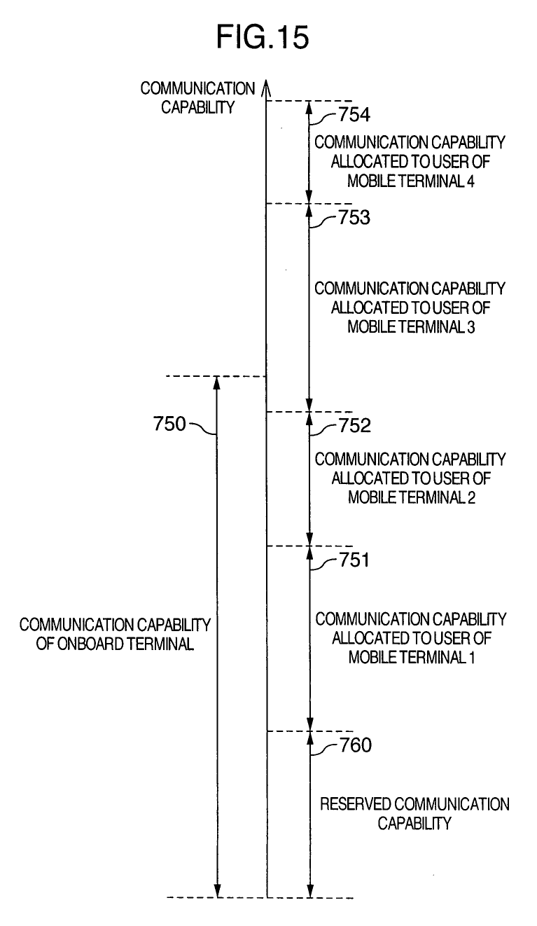

FIG. 15 shows a second example of the communication capability allocation procedure 711. Similar to the first example shown in FIG. 15, this second example shown in FIG. 15 is the case where the communication capability of the onboard terminal 200 is allocated to four user's mobile terminals. In the procedure shown in FIG. 15, the onboard terminal 200 extracts a reserved communication capability 760 from its own communication capability 750, holds it, and allocates the remaining communication capability to the respective mobile terminals in the same way as described with reference to FIG. 14. The reserved communication capability 760 mentioned here includes such communication capabilities as communication capability required for downloading road information, traffic conditions and map information used in the practice of car navigation and communication capability required for transmitting emergency reports in case of, for example, accidents.

As shown in the flow chart of FIG. 13, the onboard terminal 200 executes the terminal selection procedure 712 for deciding on whether the terminal to be used for the continuous execution of the application is the onboard terminal 200 or the mobile terminals 100 and 101, on the basis of the result of the communication capability allocation procedure 711. The detail of the terminal selection procedure 712 will be described later. The onboard terminal 200 informs the mobile terminals 100 and 101 of the selection result obtained through the terminal selection procedure 712. Further, the onboard terminal 200 decides on whether or not the terminal handover is to be executed with respect to the mobile terminals 100 and 101, respectively, on the basis of the selection result obtained through the terminal selection procedure 712 (steps 713 and 715). The operations specified by the steps 713 and 715 are the same as the operation specified by the step 412 shown in FIG. 5.

When the step 713 selects the “Yes” branch, the terminal selection procedure 604 for the mobile terminal 100 in FIG. 12 is executed so that the intended terminal handover is performed. On the other hand, when the step 713 selects the “No” branch, the onboard terminal 200 does not execute the terminal handover for the mobile terminal 100. In like manner, according to the selection result of the step 715, the terminal handover procedure 605 for the mobile terminal 101 shown in FIG. 12 is or is not performed.

The detail of the terminal selection procedure 712 shown in FIG. 13 will now be described below. In the terminal selection procedure 712, each of the mobile terminals 1 through 4 is subjected to the decision on whether it is used or the onboard terminal is used, for communication capability allocation. In more detail, it is assumed that in the communication capability allocation procedure 711, for example, communication capabilities are allocated to the corresponding mobile terminals 1 through 4 as shown in FIG. 14. In this case, since the sum of the communication capability 751 allocated to the mobile terminal 1 and the communication capability 752 allocated to the mobile terminal 2 is smaller than the communication capability 750 of the onboard terminal, the onboard terminal can allocate the required parts of its communication capability 750 to the mobile terminals 1 and 2. However, since the sum of the communication capability 751 allocated to the mobile terminal 1, the communication capability 752 allocated to the mobile terminal 2 and the communication capability 753 allocated to the mobile terminal 3 is larger than the communication capability 750 of the onboard terminal, the onboard terminal cannot allocate the required communication capabilities to all the mobile terminals 1 through 3. As already described with reference to FIG. 14, it is assumed that the priorities of the mobile terminals 1 and 2 are higher than those of the mobile terminals 3 and 4. Accordingly, in this case, the terminal selection procedure 712 passes a decision that the mobile terminals 1 and 2 use the “onboard terminal” for communication capability allocation while the mobile terminal 3 or 4 use the “mobile terminal” for communication capability allocation.

For the operations of the mobile terminals 100 and 101 in the communication capability allocation and terminal handover decision procedure 700, the operational flow of the mobile terminal shown in FIG. 8 have only to be followed.

In the fourth embodiment shown in FIG. 12, a case is described where the mobile terminal 100 is already in the automobile and then the mobile terminal 101 moves into the same automobile. However, even in case where the mobile terminals 100 and 101 simultaneously move into the automobile, if the operational flow shown in FIG. 13 is followed, then the allocation of communication capabilities, the terminal selection depending on the communication capability allocation, and the terminal handover depending on the terminal selection can be performed. Moreover, this invention can also be applied to the case where more than two mobile terminals are involved, in the same way as described above.

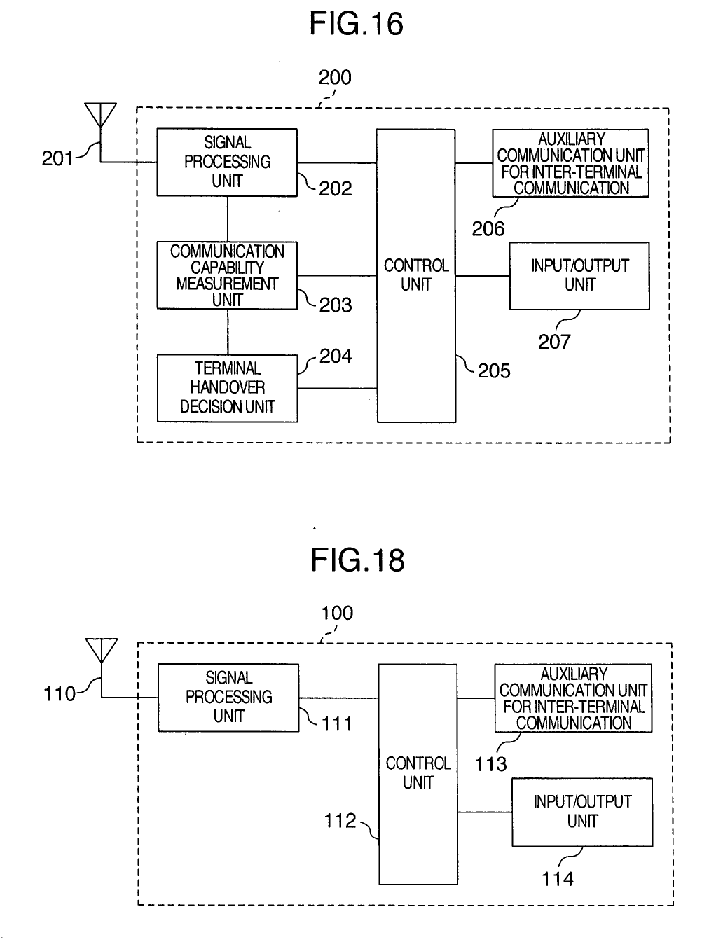

FIG. 16 shows in block diagram an example of the structure of the onboard terminal 200 which executes the terminal handover procedure flow according to this invention. An antenna 201 performs the transmission and reception of the radio signal for communicating with the wireless access network. A signal processing unit 202 modulates the transmission data to form the transmission signal to be sent to the antenna 201. The transmission signal includes, for example, application data 308 and terminal handover start signal 306. A signal processing unit 202 demodulates the signal received by the antenna 201 and derives the reception data from the received signal. The received signal includes the application data 308, etc. The signal processing unit 202 comprises, for example, an analog circuit for processing high frequency signals and a logic circuit or a processor for processing digital signals.

A control unit 205 controls the onboard terminal 200 as a whole and processes communication protocols. The control unit 205 is realized, for example, by using a program operable on a processor.

An input/output unit 207 serves as an interface for the onboard terminal 200 and may be composed of a liquid crystal display, a touch panel, etc.

An auxiliary communication unit 206 for inter-terminal communication performs signal and protocol processing so that the onboard terminal 200 can communicate directly with the mobile terminal 100 or 101 without intermediary role of the core network 10. The auxiliary communication unit 206 can be realized by using, for example, a conventional wireless communication module for use in a wireless LAN or a Bluetooth network. The signal inputted into the auxiliary communication unit 206 includes the terminal handover request 305, etc. while the signal outputted from the auxiliary communication unit 206 includes the terminal handover request 320, the selection results of the terminal selection procedures 411 and 712, etc.

A communication capability measurement unit 203 executes the communication capability measurement procedures 410 and 710 in the procedure flow shown in FIGS. 5 and 13. The communication capability measurement unit 203 structurally comprises, for example, a counter for counting the number of the received data and a timer for measuring time. In such a case, the communication capability measurement unit 203 causes the counter to count the number of the data received for a predetermined length of time measured by the timer so that the average data rate can be determined by dividing the counted data number by the predetermined length of time.

A terminal handover decision unit 204 executes the terminal selection procedure 411 and the terminal handover execution step 412 in the procedure flow shown in FIG. 5 and also executes the communication capability allocation procedure 711 and the terminal handover execution steps 713 and 715 in the procedure flow shown in FIG. 13. The terminal handover decision unit 204 is realized, for example, by using a program operable on a processor equivalent to the control unit 105.

FIG. 18 shows in block diagram an example of the structure of the mobile terminal 100 which executes the terminal handover procedure flow according to this invention. An antenna 110 and a signal processing unit 111 have the same functions and structures as the antenna 201 and the signal processing unit 202 of the onboard terminal 200 shown in FIG. 16 have. The transmission signal generated by the signal processing unit 202 and transmitted at the antenna 201 includes the application data 300, the terminal handover request 321, etc. The signal received at the antenna 201 and demodulated by the signal processing unit 202 includes the application data 300, etc.

A control unit 112 controls the mobile terminal 100 as a whole and processes communication protocols involved. The control unit 112 is realized, for example, by using a program operable on a processor.

An input/output unit 114 is a user interface for the mobile terminal 100 and comprises a liquid crystal display, a keyboard, etc.

An auxiliary communication unit 113 for inter-terminal communication performs signal and protocol processing so that the onboard terminal 200 can communicate directly with the mobile terminal 100 without intermediary role of the core network 10. The auxiliary communication unit 206 can be realized by using, for example, a conventional wireless communication module for use in a wireless LAN or a Bluetooth network. The signal inputted into the auxiliary communication unit 113 includes the terminal handover request 320, the selection results of the terminal selection procedures 411 and 712, etc. while the signal outputted from the auxiliary communication unit 113 includes the terminal handover request 305, etc.

In order to realize the procedure flows shown in FIGS. 3 and 4, the control unit 112 is provided with a function for executing the terminal handover decision procedure shown in FIG. 8 and the terminal handover procedures 322, 604 and 605 depending on the terminal handover request 320 informed of by the onboard terminal 200 and the selection result of the terminal selection procedures 411 and 712, in addition to the function for executing the conventional procedure flow shown in FIG. 17.

In the foregoing description, the details of this invention are described as it is applied to an onboard terminal installed on an automobile. However, a terminal installed on a bus, an electric train, an airplane, a ship, etc. can execute the same procedures as described above in the embodiments of this invention. Therefore, such applications, too, will fall within the scope of this invention.

It should be further understood by those skilled in the art that although the foregoing description has been made on embodiments of the invention, the invention is not limited thereto and various changes and modifications may be made without departing from the spirit of the invention and the scope of the appended claims.

1. A method for performing the terminal handover wherein a user of a wireless communication system can switch from a first terminal to a second terminal while continuously enjoying an application being executed through the wireless communication system, comprising:
a first step for causing the second terminal to measure its own communication capability;
a second step for deciding on whether or not the terminal handover from the first terminal to the second terminal is to be executed, depending on the measured communication capability;
a third step for transferring the result of decision obtained in the second step from the second terminal to the first terminal; and
a fourth step for executing the terminal handover procedure when the decision in the second step is that the terminal handover is to be performed.

2. A method for performing the terminal handover as claimed in claim 1, wherein the first through fourth steps are executed when the first terminal issues the terminal handover request.

3. A method for performing the terminal handover as claimed in claim 1, wherein the first through fourth steps are executed regularly at predetermined intervals.

4. A method for performing the terminal handover as claimed in claim 1, wherein the first through fourth steps and a fifth step are executed when the second terminal changes its wireless communication system in current use to another communication system.

5. A method for performing the terminal handover as claimed in claim 1, wherein the first step causes the second terminal to measure the data rate of the wireless communication system which the second terminal is using, as its own communication capability.

6. A method for performing the terminal handover as claimed in claim 1, wherein the second step makes a decision that the terminal handover is possible if the communication capability of the second terminal is higher than that of the first terminal.

7. A method for performing the terminal handover as claimed in claim 1, wherein the second step makes a decision that the terminal handover is possible if the communication capability of the second terminal is higher than the communication capability required for the second terminal to execute the application.

8. A method for performing the terminal handover between first plural terminals and a second terminal,
wherein a user of a wireless communication system can switch from one available terminal to another while continuously enjoying an application being executed through the wireless communication system, said method comprising:
a first step for causing the second terminal to measure its own communication capability;
a second step for deciding on the allocation of the measured communication capability to the plural first terminals;
a third step for causing the second terminal to transfer the decision result obtained in the second step to the respective first terminals; and
a fourth step for performing the terminal handover from the first terminal deemed to be subjected to handover depending on the decided allocation, to the second terminal.

9. A method for performing the terminal handover as claimed in claim 8, wherein the second terminal measures the data rate of the wireless communication system which it is using, as its own communication capability.

10. A method for performing the terminal handover as claimed in claim 8, wherein the second step causes the second terminal to give priority to the users of the plural first terminals or the applications in accordance with the predetermined way of setting priority; and the second terminal allocates its communication capability to the plural first terminals in accordance with the given priority.

11. A method for performing the terminal handover as claimed in claim 10, wherein the predetermined way of setting priority causes the second terminal to give higher priority to a user or an application that needs higher communication capability.

12. A method for performing the terminal handover as claimed in claim 10, wherein the predetermined way of setting priority causes the second terminal to set priority depending on the users of the plural first terminals.

13. A method for performing the terminal handover as claimed in claim 10, wherein the predetermined way of setting priority causes the second terminal to set priority to the plural first terminals depending on the kinds of applications that the plural first terminals are executing.

14. A method for performing the terminal handover as claimed in claim 8, wherein the second step causes the second terminal to subtract a predetermined communication capability from the communication capability measured in the first step and to allocate the remaining communication capability to the plural first terminals.

15. An apparatus for performing the terminal handover wherein a user of a wireless communication system can switch from one available terminal to another while continuously enjoying an application being executed through the wireless communication system, comprising:
a signal processing unit for communication with an application server via a network;
an auxiliary communication unit for inter-terminal communication;
a communication capability measurement unit for measuring communication capability;
a control unit for controlling the terminals and for generating a signal for communication with the application server; and
a terminal handover decision unit;
wherein the terminal handover decision unit decides on whether the terminal handover is to be executed with respect to the terminal for which handover is requested, depending on the measured communication capability; the control unit generates a control signal for controlling the terminal handover depending on the result of decision; and the signal processing unit transmits and receives the control signal.

16. An apparatus for performing the terminal handover wherein a user of a wireless communication system can switch from one available terminal to another while continuously enjoying an application being executed through the wireless communication system, comprising:
a signal processing unit for communication with an application server via a network;
an auxiliary communication unit for communicating with at least one other terminal;
a communication capability measurement unit for measuring communication capability;
a control unit for controlling the terminals and for generating a signal for communication with the application server; and
a terminal handover decision unit;
wherein the terminal handover decision unit decides on whether the terminal handover is to be executed with respect to the at least other terminal, depending on the measured communication capability; the control unit generates a control signal for controlling the terminal handover depending on the result of decision; and the auxiliary communication unit transmits and receives the control signal to and from the at least one other terminal.

17. An apparatus for performing the terminal handover as claimed in claim 16, wherein the communication capability measurement unit measures communication capability at predetermined time intervals.

18. An apparatus for performing the terminal handover as claimed in claim 16, wherein when the wireless communication system being used by the signal processing unit is changed to another wireless communication system, the communication capability measurement unit measures the communication capability of the wireless communication system to be used after the change.

19. An apparatus for performing the terminal handover as claimed in claim 16, wherein the terminal handover decision unit allocates the measured communication capability to the at least one other terminal, and decides on whether nor not the terminal handover is to be executed, depending on the allocated communication capability.
